(19) United States
(12) Patent Application Publication
(10) Pub. No.: US 2026/0281532 A1
(43) Pub. Date: Sep. 17, 2026

(54) INFORMATION HANDLING SYSTEM CAMERA SWAPPABLE EMITTER

(71) Applicant: Dell Products L.P., Round Rock, TX (US)

(72) Inventors: Wei Hsiang Chi, Taipei (TW); Chiu Jung Tsen, Zhubei (TW); Jace W. Files, Round Rock, TX (US); John Trevor Morrison, Round Rock, TX (US); Yao Hsien Huang, New Taipei (TW)

(73) Assignee: Dell Products L.P., Round Rock, TX (US)

(21) Appl. No.: 19/077,167

(22) Filed: Mar. 12, 2025

(51) Int. Cl. H04N 23/56; G06F 1/16; H04N 23/20; H04N 23/54; H04N 23/57

(52) U.S. Cl. CPC H04N 23/56; G06F 1/1686; H04N 23/20; H04N 23/54; H04N 23/57

(57) ABSTRACT

A portable information handling system camera module couples to an infrared emitter on a daughter board with a clip bracket that has a planar portion at the back of the camera module and spring finger pressing down on landing pads at the front side of the daughter board. The landing pads thermally couple with the infrared emitter to reject excess thermal energy to the bracket. At application of power, the infrared emitter generates an identification signal to identify the type of infrared emitter, such as a pull up for a VCSEL emitter and a pull down for an LED emitter.

### BACKGROUND OF THE INVENTION

### Field of the Invention

The present invention relates in general to the field of portable information handling systems, and more particularly to an information handling system camera swappable emitter.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Portable information handling systems integrate processing components, a display and a power source in a portable housing to support mobile operations. Portable information handling systems allow end users to carry a system between meetings, during travel, and between home and office locations so that an end user has access to processing capabilities while mobile. Tablet configurations typically expose a touchscreen display on a planar housing that both outputs information as visual images and accepts inputs as touches. Convertible configurations typically include multiple separate housing portions that couple to each other so that the system converts between closed and open positions. For example, a main housing portion integrates processing components and a keyboard and rotationally couples with hinges to a lid housing portion that integrates a display. In clamshell configuration, the lid housing portion rotates approximately ninety degrees to a raised position above the main housing portion so that an end user can type inputs while viewing the display. After usage, convertible information handling systems rotate the lid housing portion over the main housing portion to protect the keyboard and display, thus reducing the system footprint for improved storage and mobility.

One common function of information handling systems is to act as a communication tool that supports videoconferencing. Convertible information handling systems often include a camera at the top side of the lid housing portion so that an end user viewing the system's integrated display will fall within the camera's field of view. This arrangement allows an end user to view a videoconference participant at the display with the camera capturing a video image showing the end user looking at the videoconference participant. The camera is also conveniently placed to perform a number of other functions, including facial identification and user presence detection. Generally, these functions are supported by infrared (IR) image capture where infrared light is emitted by an IR emitter coupled in the housing lid near the camera. Typically, the IR emitter is soldered or otherwise fixed in the housing, such as by integrating the IR emitter as part of a printed circuit board that supports the camera. One difficulty with this approach is that the camera assembly lacks flexibility to adapt to different emitter designs. Another difficulty is that the type and/or model of emitter is not generally discoverable by the camera so that the emitter characteristics may not be known by the camera firmware. Another difficulty is that the emitter thermal characteristics may vary so that the camera module design has to adapt to multiple thermal profiles. As an example, IR emitters of light emitting diode (LED) design tend to use less power and generate less illumination than IR emitters of vertical cavity surface emitting laser (VCSEL) design.

### SUMMARY OF THE INVENTION

Therefore, a need has arisen for a system and method which adaptively couples an illumination emitter to an information handling system camera module.

In accordance with the present invention, a system and method are provided which substantially reduce the disadvantages and problems associated with previous methods and systems of providing illumination by an emitter at an information handling system. An emitter, such as an infrared emitter, couples to a camera module in a swappable manner so that the camera module adapts to different information handling systems to support capture of visual images.

More specifically, an information handing system processes information with a processor and memory coupled in a portable housing. A camera module couples in the portable housing, such as behind a display integrated in the portable housing to present the information as visual images. The camera module couples a camera to a printed circuit board that interfaces a processing resource and plural contacts configured to interface with an infrared emitter. The infrared emitter is coupled to a daughter board front side and interface with spring biased connectors on the daughter board rear side. A bracket placed around the camera module rear side presses with spring fingers against the daughter board front side to hold the daughter board in place with the spring biased connectors against the contact pads. Landing pads on the daughter board front side provides a solid surface against which the spring fingers of the bracket press and also a thermal interface to reject excess thermal energy from the emitter to the bracket.

The present invention provides a number of important technical advantages. One example of an important technical advantage is that an emitter has a modular form coupled to a daughter board to support a camera module in a swappable manner that allows the same camera module to support different information handling systems with different emitters. The swappable daughter board arrangement clips into place with a bracket that also helps to transfer thermal energy from the emitter. In one embodiment, a camera module with two swappable emitters having VCSEL infrared devices dissipates 7.7 W of power each with the excess thermal energy from the emitters rejected by the bracket clips holding the daughter board in place.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an information handling system having a camera module with a swappable emitter;

FIGS. 2 and 2A depict the camera module having the swappable emitter configured to couple by a bracket clip;

FIG. 3 depicts a detailed perspective view of the swappable emitter coupled to the camera module by the bracket clip;

FIG. 4 depicts an example embodiment having a VCSEL swappable emitter indicated to the camera module; and

FIG. 5 depicts an example embodiment having an LED swappable emitter indicated to the camera module.

### DETAILED DESCRIPTION

A swappable emitter couples by a bracket clip to an information handling system camera module. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

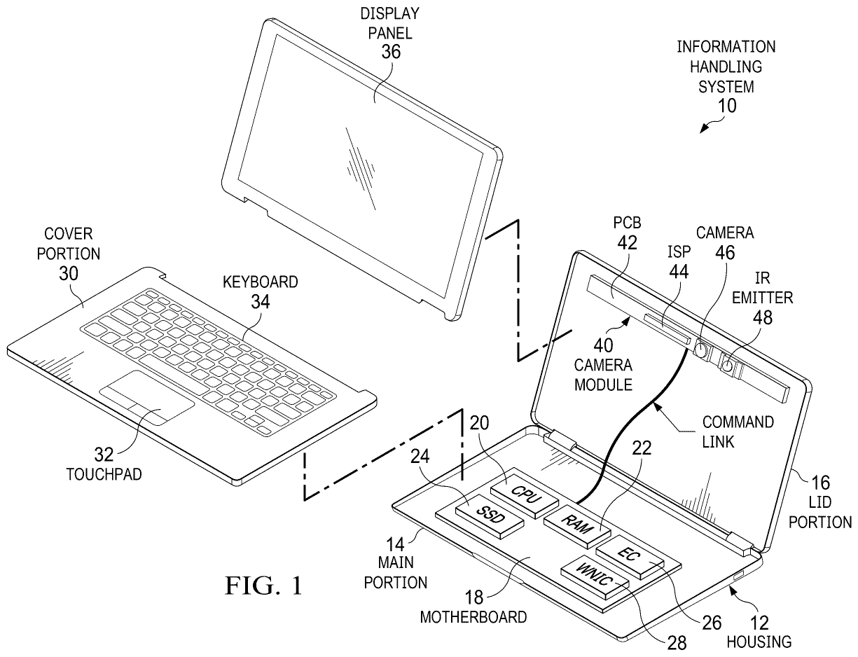

Referring now to FIG. 1, an information handling system 10 is depicted having a camera module 40 with a swappable emitter 48. In the example embodiment, information handling system 10 has a portable configuration with a portable housing 12 having a main portion 14 rotationally coupled to a lid portion 16. Housing main portion 14 couples a motherboard 18 in an interior that supports interactions between plural processing components. A central processing unit (CPU) 20 executes instructions to process information in cooperation with a random access memory (RAM) 22 that stores the instructions and information. A solid state drive (SSD) 24 has non-transient memory that stores the instructions and information when the system is powered down. An embedded controller 26 manages operational conditions at the system, such as application of power and maintenance of thermal constraints. A wireless network interface controller (WNIC) 28 provides communication with external devices and networks. A housing cover portion 30 couples over main portion 14 to enclose the processing components and support a keyboard 34 and touchpad 32 that accept end user inputs.

In the example embodiment, a display panel 36 couples in housing lid portion 16 and interfaces with CPU 20 to present the information as visual images. Camera module 40 couples to housing lid portion 16 behind display panel 36 with a camera 46 having a field of view through the display panel to capture visual images of the viewing area in front of display panel 36. Camera module 40 has a printed circuit board 42 in communication with motherboard 18 and supporting coupling of camera 46 in position to capture visual images. A processing resource 44, such as an image signal processor, interfaces with camera 46 to process visual images captured by camera 46, such as to support image processing like video compression. An infrared emitter 48 couples near camera 46 to provide infrared illumination in support of camera visual image capturing, such as in low light conditions or to capture three dimensional images. As is described in greater detail below, the infrared emitter is swappable with a modular design so that multiple types of emitters are supported with a single camera module arrangement. The type of emitter coupled in place is automatically detected by logic of the processing resource or other firmware arrangements. The bracket clip arrangement to couple the swappable emitter in place aids in thermal management across different emitter types having different power use and illumination characteristics. As an example, the emitter may include light emitting diode (LED) and vertical cavity surface emitting laser (VCSEL) designs.

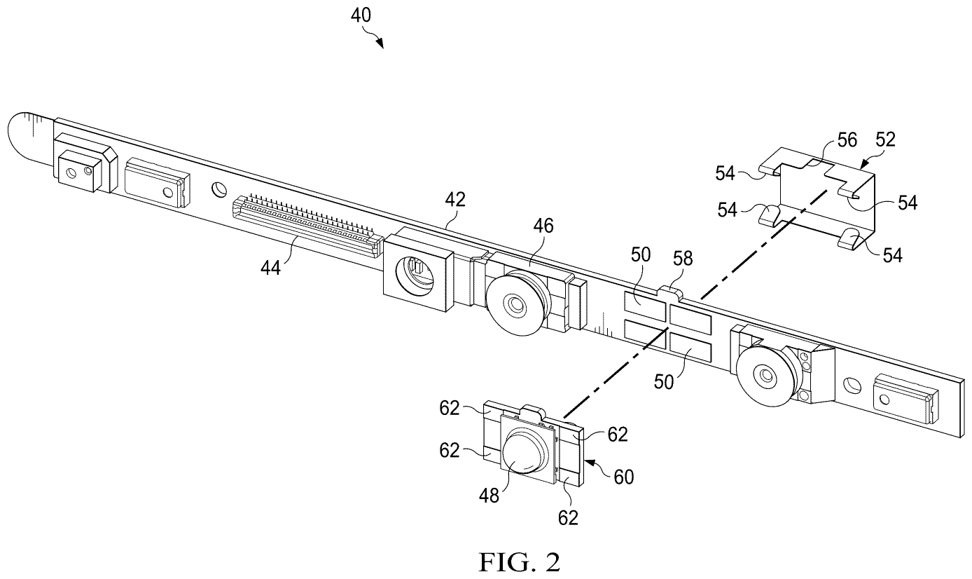

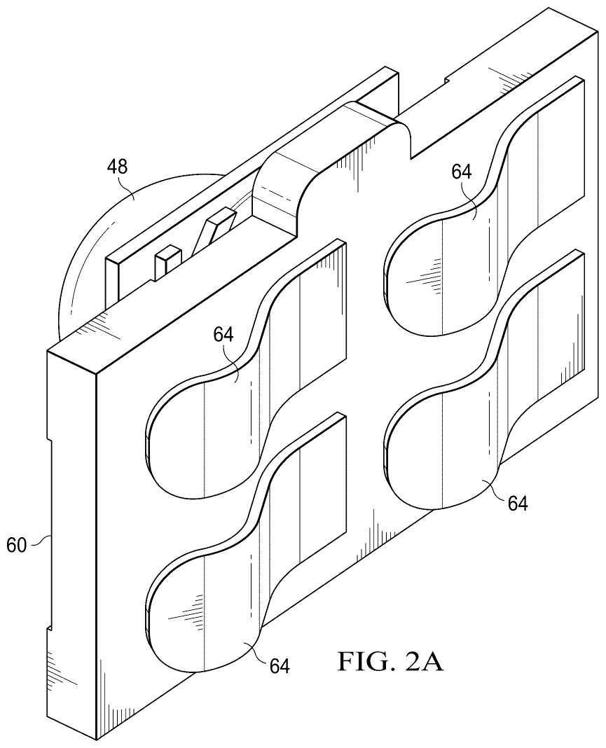

Referring now to FIGS. 2 and 2A, the camera module 40 is depicted having the swappable emitter 48 configured to couple by a bracket clip 52. In the example embodiment, camera module 40 is built on a printed circuit board 42 that interfaces a processing resource 44, such as an image sensor processor (ISP), with a camera 46 having a lens and image sensor. In alternative embodiments, processing resource 44 may be a microcontroller unit (MCU), digital signal processor (DSP), user presence detection (UPD) artificial intelligence (AI) unit or other type of processing resource. In various embodiments, multiple processing resources and cameras may be included on printed circuit board 42, such as separate visible light and infrared cameras. An infrared emitter 48 couples to a daughter board 60 and is depicted aligned to couple to camera module 40 in a swappable manner with a bracket 52 having a clip configuration. In various embodiments, other types of emitters may be used, such as white light emitters. Bracket 52 is, for example, a metallic material like steel or stainless steel.

Daughter board 60 has infrared emitter 48 coupled to a front side along with four landing pads 62 in each corner with a rectangular layout. Landing pads 62 perform dual roles of accepting a coupling force from bracket 52 and thermally interfacing with infrared emitter 48 to reject thermal energy from the daughter board to bracket 52. FIG. 2A depicts the rear side of daughter board 60, which as four spring biased connectors 64 that interface with infrared emitter 48 to communicate power from printed circuit board 42. Contact pads 50 coupled to the front side of printed circuit board 42 align with spring biased connectors 64 so that an electrical interface is established between printed circuit board 42 and daughter board 60 when the daughter board is pressed against the camera module by bracket 52. Bracket 52 has a planar main section that presses against the rear side of printed circuit board 42 and four spring fingers 54 that extend forward past the daughter and bend back to press inwards against landing pads 62, thereby holding daughter board 60 spring biased connectors 64 against contact pads 50. To aid in the alignment of the spring biased connectors and contact pads, a tab 58 extending up from printed circuit board 42 engages in a notch 56 of bracket 52.

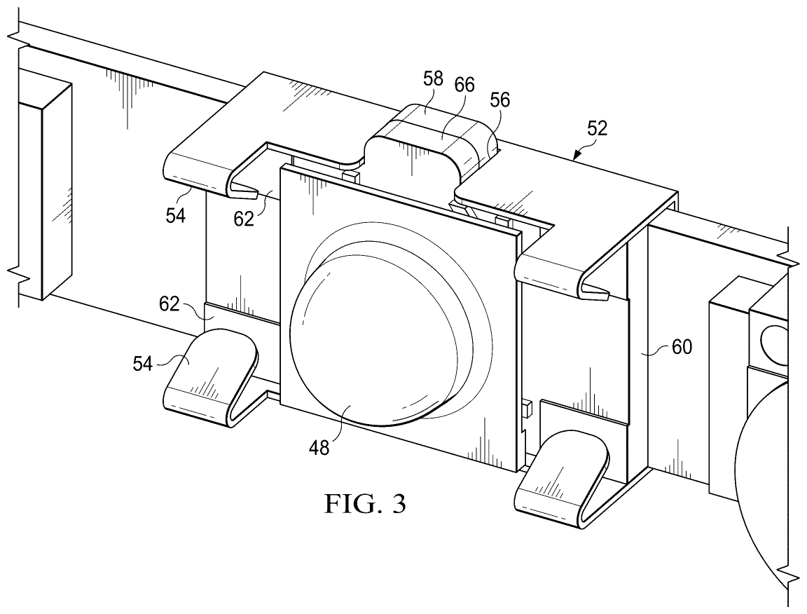

Referring now to FIG. 3, a detailed perspective view depicts the swappable emitter 48 coupled to the camera module by the bracket clip. Daughter card 60 with emitter 48 coupled at a front face presses against the camera module to interface the spring biased connectors on its rear side with the contact pads on the front of the camera module printed circuit board. A tab 58 of the printed circuit board and a tab 66 of the daughter board align in a notch 56 of bracket 52 to align the connectors and pads. Spring fingers 54 of bracket 52 bend back towards landing pads 62 to apply a compression force against the daughter board. Bracket 52 acts as a clip connector that snaps into place around the camera module rear side and is made of a metallic material that thermally couples with the landing pads to accept thermal energy of emitter 48. Assembly and disassembly of daughter board 60 is performed in a toolless manner by snapping in place.

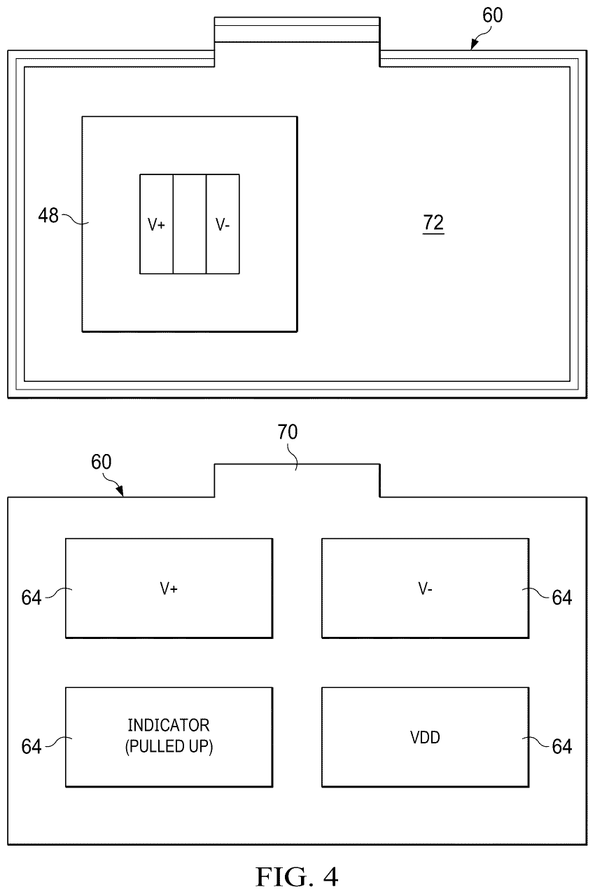

Referring now to FIG. 4, an example embodiment depicts a VCSEL swappable emitter indicating its type to the camera module. In the example embodiment, daughter board 60 front side 72 accepts a VCSEL emitter 48 indicated by the footprint. When power is applied to the contact pads of the camera module, the spring biased contacts 64 at the daughter board 60 back side 70 output an indication of a pull up so that a processing resource executing firmware on the camera module can detect that the motherboard has a VCSEL type of emitter, such as with a high signal to a GPIO pin in. For instance, the daughter board couples either VDD or ground with an appropriate impedance based upon the type of emitter assembled to the daughter board.

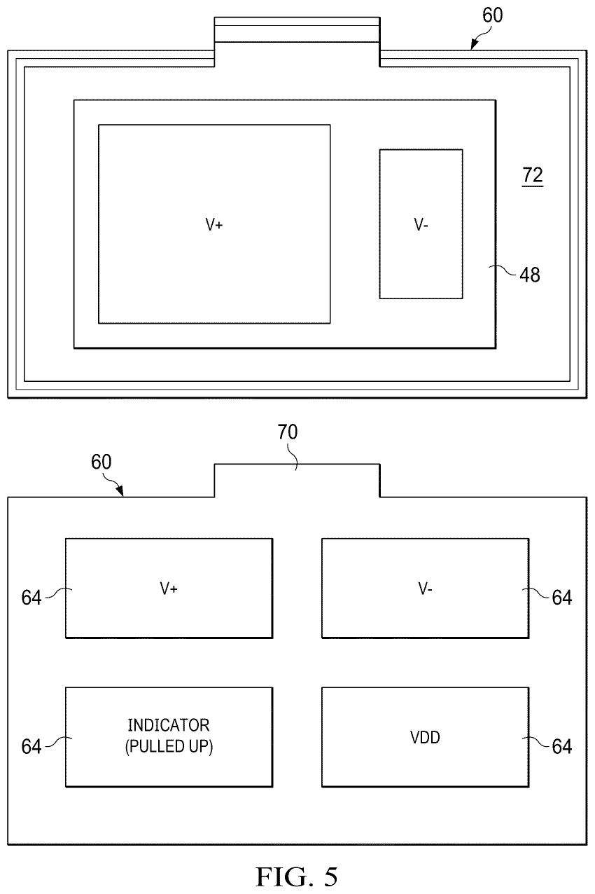

Referring now to FIG. 5, an example embodiment depicts an LED swappable emitter indicating its type to the camera module. In the example embodiment, daughter board 60 front side 72 accepts an LED emitter 48 indicated by the footprint. When power is applied to the contact pads of the camera module, the spring biased contacts 64 at the daughter board 60 back side 70 output an indication of a pull down so that a processing resource executing firmware on the camera module can detect that the motherboard has an LED type of emitter, such as with a low signal to a GPIO pin in. For instance, the daughter board couples either VDD or ground with an appropriate impedance based upon the type of emitter assembled to the daughter board. In alternative embodiments, other types of emitters may be indicated, such as with additional contacts or timed signal patterns through the single contact, such as with an RC circuit.

Although the present invention has been described in detail, it should be understood that various changes, substitutions and alterations can be made hereto without departing from the spirit and scope of the invention as defined by the appended claims.

What is claimed is:

1. An information handling system comprising:
a housing;
a processor coupled in the housing and operable to execute instructions that process information;
a memory coupled in the housing and interfaced with the processor, the memory operable to store the instructions and information;
a camera module coupled to the housing and interfaced with the processor, the camera module having a camera coupled to a printed circuit board, an image processing resource coupled to the printed circuit board and interfaced with the camera to manage camera operations, and plural contacts pads exposed at the printed circuit board and interfaced with the image processing resource; and
an emitter coupled to a daughter board and operable to emit illumination when power is applied to the emitter through one or more spring biased contacts pressed against one or more of the plural contact pads.

2. The information handling system of claim 1 further comprising:
a bracket having a planar portion pressed against the printed circuit board rear side and plural spring fingers extending towards the daughter board front side; and
plural landing pads coupled to the daughter board front side, each of the plural spring fingers resting on one of the plural landing pads to press the daughter board against the printed circuit board.

3. The information handling system of claim 2 wherein the emitter thermally couples with the plural landing pads to reject thermal energy to the bracket.

4. The information handling system of claim 2 further comprising:
four landing pads coupled to the daughter board front side in a rectangle pattern; and
four spring fingers extending from the bracket and aligned to press against the four landing pads.

5. The information handling system of claim 4 wherein the emitter comprises an infrared light emitting diode emitter.

6. The information handling system of claim 4 wherein the emitter comprises a vertical cavity surface emitting laser.

7. The information handling system of claim 2 further comprising:
four contact pads exposed at a front side of the printed circuit board; and
four spring biased contacts coupled to the daughter board rear side aligned to press against the four contact pads when the bracket engages the daughter board against the printed circuit board.

8. The information handling system of claim 7 further comprising:
a non-transient memory storing instructions that when executed on the processing resource cause:
detection of a pull-up current at one of the four contact pads to indicate a first type of emitter; and
detection of a pull-down current at one of the four contact pads to indicate a second type of emitter.

9. The information handling system of claim 7 further comprising:
an alignment tab extending forward from the bracket planar portion; and
an alignment notch formed in the printed circuit board to accept the alignment tab when the bracket couples the daughterboard to the printed circuit board.

10. A method for assembly of an information handling system, the method comprising:
coupling an infrared emitter to a daughter board front side;
coupling a camera to a camera module printed circuit board front side;
pressing the daughter board rear side against the camera module printed circuit board with a bracket having a planar surface against the camera module printed circuit board and plural spring fingers extending past and then pressing against the daughter board front side;
coupling the camera module printed circuit board to the information handling system; and
communicating power to the infrared emitter with an interface between the camera module printed circuit board front side and the daughter board rear side.

11. The method of claim 10 further comprising:
coupling four spring biased contacts to the rear side of the daughter board; and
coupling four contact pads to the camera module printed circuit board to align with the spring biased contacts when the bracket presses the daughter board against the camera module printed circuit board.

12. The method of claim 11 further comprising:
forming a notch in the bracket; and
fitting the notch at a member extending from the camera module printed circuit board to align the spring biased contacts and the camera module printed circuit board.

13. The method of claim 10 further comprising:
coupling landing pads to the front side of the daughter card;
pressing bracket spring fingers against the landing pads; and
thermally interfacing the infrared emitter with the landing pads to reject thermal energy to the bracket.

14. The method of claim 10 further comprising:
detecting with a processing resource on the camera module printed circuit board a signal from the infrared emitter; and
applying the signal to identify the infrared emitter as a first type or a second type.

15. The method of claim 14 further comprising:
detecting an LED infrared emitter when a pull down is detected from the infrared sensor; and
detecting a VCSEL infrared emitter when a pull up is detected.

16. A camera module comprising:
a printed circuit board;
a camera coupled to the printed circuit board;
a processing resource coupled to the printed circuit board and interfaced with the camera to manage camera operations;
plural contact pads exposed at the printed circuit board and interfaced with the image processing resource; and
an emitter coupled to a daughter board and operable to emit illumination when power is applied to the emitter through one or more spring biased contacts pressed against one or more of the plural contact pads.

17. The camera module of claim 16 further comprising:
a bracket having a planar portion pressed against the printed circuit board rear side and plural spring fingers extending towards the daughter board front side; and
plural landing pads coupled to the daughter board front side, each of the plural spring fingers resting on one of the plural landing pads to press the daughter board against the printed circuit board.

18. The camera module of claim 17 further comprising:
a non-transient memory storing instructions that when executed on the processing resource cause:
detection of a pull-up current at one of the plural contact pads to indicate a first type of emitter; and
detection of a pull-down current at one of the four contact pads to indicate a second type of emitter.

19. The camera module of claim 18 further comprising:
four contact pads exposed at a front side of the printed circuit board; and
four spring biased contacts coupled to the daughter board rear side aligned to press against the four contact pads when the bracket engages the daughter board against the printed circuit board.

20. The camera module of claim 19 further comprising:
four landing pads coupled to the daughter board front side in a rectangle pattern and thermally coupled with the emitter; and
four spring fingers extending from the bracket and aligned to press against the four landing pads.
